(19) United States
(12) Patent Application Publication
(10) Pub. No.: US 2010/0017064 A1
(43) Pub. Date: Jan. 21, 2010

(54) METHOD FOR TUNING ELECTRIC POWER STEERING APPARATUS

(75) Inventor: Atsushi Kojima, Maebashi-Shi (JP)

Correspondence Address: SUGHRUE MION, PLLC, 2100 PENNSYLVANIA AVENUE, N.W., SUITE 800, WASHINGTON, DC, 20037, US

(73) Assignee: NSK Ltd., Shinagawa-Ku, Tokyo (JP)

(21) Appl. No.: 12/446,651

(22) PCT Filed: Oct. 22, 2007
(86) PCT No.: PCT/JP2007/070971

§ 371 Date: Apr. 22, 2009

(30) Foreign Application Priority Data
Oct. 30, 2006 (JP) 2006-293439

(51) Int. Cl. G06F 19/00; B62D 6/00

(52) U.S. Cl. 701/42

(57) ABSTRACT

An electric power steering apparatus is tuned by a step-1 that sets a predetermined parameter value to a tuning device; a step-2 that inputs a target steering torque to the tuning device; a step-3 that calculates a rack thrust force based on a steering torque measured by a sensor system; a step-4 that calculates a necessary motor current based on the step-1 to the step-3; and a step-5 that sets an assist map based on the necessary motor current for tuning.

### TECHNICAL FIELD

The present invention relates to a method for tuning an electric power steering apparatus that provides a steering assist force of a motor to a steering system of a vehicle. More specifically, the present invention relates to a method for tuning an electric power steering apparatus that calculates a setting of a necessary assist steering torque to a tuning device and a control unit incorporated into a real vehicle by a rack thrust force (tire reaction force) to adjust a motor current, thereby increasing the operation efficiency in a tuning process and reducing a cost.

### BACKGROUND ART

An electric power steering apparatus subjects a steering device of a vehicle to assist load energization with the rotational force of a motor. The electric power steering apparatus subjects a steering shaft or a rack shaft to assist load energization with the driving force of the motor via a speed reducer by a transmission mechanism, such as gears or a belt. Such electric power steering apparatus in the related art performs a feedback control of a motor current in order to precisely generate an assist steering torque (steering torque). The feedback control adjusts a motor applying voltage so that the difference between a current command value and a detected motor current value is small or zero. The motor applying voltage is typically adjusted by the adjustment of a duty ratio of PWM (pulse width modulation) control.

The typical configuration of the electric power steering apparatus will be described with reference to FIG. 1. A column shaft 2 of a steering wheel 1 is coupled to a tie rod 6 of steered wheels via reducing gears 3, universal joints 4a and 4b and a pinion rack mechanism 5. A torque sensor 10 that detects a steering torque Th of the steering wheel 1 is provided on the column shaft 2. A motor 20 that assists the steering force of the steering wheel 1 is coupled to the column shaft 2 via the reducing gears 3. An electric power is supplied from a battery 14 to a control unit 30 that controls the power steering apparatus. An ignition key signal is inputted to the control unit 30 via an ignition key 11. The control unit 30 calculates a steering assist command value I of an assist command based on the steering torque Th detected by the torque sensor 10 and a vehicle speed V detected by a vehicle speed sensor 12, and controls a current supplied to the motor 20 based on the calculated steering assist command value I.

The control unit 30 is mainly constructed with a CPU (including an MPU (Micro Processor Unit) or an MCU (Micro Controller Unit)), and a typical function executed by a program in the CPU is illustrated in FIG. 2.

The function and operation of the control unit 30 will be described with reference to FIG. 2. The steering torque Th detected by the torque sensor 10 is inputted to a steering assist command value calculating section 32, and the vehicle speed V detected by the vehicle speed sensor 12 is also inputted to the steering assist command value calculating section 32. Based on the inputted steering torque Th and vehicle speed V, the steering assist command value calculating section 32 refers to an assist map (look-up table) 33 to determine the steering assist command value I as a control target value of a current supplied to the motor 20. The steering assist command value I is inputted to a subtracting section 30A and a differential compensating section 34 of a feedforward system for increasing a response speed. The difference (I−Im) obtained at the subtracting section 30A is inputted to a proportion calculating section 35 and an integration compensating section 36 for improving the characteristic of a feedback system. The proportion output of the proportion calculating section 35 is inputted to an adding section 30B. The outputs of the differential compensating section 34 and the integration compensating section 36 are also inputted to the adding section 30B. A current control value E as the added result at the adding section 30B is inputted as a motor driving signal to a motor driving circuit 37. The motor current Im of the motor 20 is detected by a motor current detecting section 38, and the motor current Im is inputted to the subtracting section 30A as a feedback current.

When the steering torque Th outputted from the electric power steering apparatus is tuned, a simulation is performed before the tuning operation of the real vehicle. A target steering torque is preliminarily determined to set the assist map 33. The comparison test of the target steering torque set to the assist map 33 and the actually outputted steering torque Th is performed by a test driver using the real vehicle. The test driver checks the magnitude of the actually outputted steering torque Th by the real vehicle. The test driver tunes the steering assist command value I so as to output the target steering torque. The test driver drives the vehicle again to check and tune the actually outputted steering torque Th. Such tuning operation tunes the outputted steering torque Th in the range of each arbitrary steering angle (e.g., every 5 [deg] of −25 [deg] to +25 [deg]) relative to each vehicle speed (e.g., every 10 [km/h] of 10 to 80 [km/h]) at a typically emphasized steering angle speed or a predetermined steering angle speed (e.g., 30 [deg/sec]) reducing the influence of a motor inertia.

The tuning of the steering torque Th outputted from the electric power steering apparatus tunes the steering assist command value I by the test driver so as to output the steering torque Th to improve the feeling during the driving of the vehicle. In the method for tuning an electric power steering apparatus, the steering assist command value I is tuned by try and error of the test driver so as to output the target steering torque Th. In the method for tuning an electric power steering apparatus in the related art, it takes significant time required for the tuning process and the cost is increased due to the use of a specific measuring device (load cell and so on) in order to calculate a rack thrust force (tire reaction force).

An apparatus disclosed in Japanese Patent Application Laid-Open (JP-A) No. 2005-59688 includes a steering force characteristic controlling means that controls a steering force characteristic, a vehicle response characteristic controlling means that controls the vehicle response characteristic of a vehicle, and a steering feeling setting means that sets a desired steering feeling. The steering feeling setting means controls the steering force controlling means and/or the vehicle response characteristic controlling means so that when a steering wheel is turned from a straight-ahead state above a predetermined vehicle speed, the steering force characteristic is almost constant at all times regardless of the change of a vehicle speed. The steering feeling (steering force characteristic) is quantified according to the environment of the vehicle. The steering torque is tuned so that the steering feeling felt by the driver is almost constant regardless of the change of a vehicle speed, a steering speed, a vehicle weight and a road surface state.

However, in the apparatus disclosed in Japanese Patent Application Laid-Open No. 2005-59688, since a lateral acceleration sensor, a steering angle sensor, a yaw rate sensor, a vehicle weight sensor and a road surface resistance sensor are used, the cost is increased and the configuration is complicated. Further, the apparatus only estimates the detected rack thrust force (tire reaction force) from a road surface. Therefore, the apparatus is not used for tuning the steering torque outputted by the electric power steering apparatus.

The present invention has been made in view of the above circumstances and an object of the present invention is to provide a method for tuning an electric power steering apparatus in which the output of each of compensating systems (such as phase compensation, inertia compensation, converging control, etc.) provided in an electric power steering apparatus is nullified, a rack thrust force during the driving of a vehicle is estimated by a tuning device from a typical sensor system (e.g., a steering angle sensor, a torque sensor, a current detecting section, etc.) provided in the electric power steering apparatus without using a special sensor or measuring device, the tuning device calculates a necessary motor current based on a detected steering torque, a calculated rack thrust force, and a target steering torque inputted to the tuning device, and an assist map of a control unit is set based on the calculated necessary motor current, thereby improving the efficiency of a tuning operation and a necessary cost and outputting an ideal steering torque.

Another object of the present invention is to provide a method for tuning an electric power steering apparatus in which after a target steering torque is satisfied (after a necessary motor current is set to an assist map) in the state of nullifying the output of each of compensating systems of an electric power steering apparatus, a simulation of the output of each of the compensating systems is performed by a tuning device so as to determine the optimum parameter of each of the compensating systems, thereby optimizing a steering assist command value and each of the compensating systems.

### DISCLOSURE OF THE INVENTION

The present invention relates to a method for tuning an electric power steering apparatus that tunes the electric power steering apparatus that calculates a steering assist command value based on an assist map provided in a control unit and controls a motor that provides a steering assist force to a steering mechanism based on the steering assist command value by a tuning device connected to the control unit. The above object of the present invention can be achieved by including a step-1 that sets a predetermined parameter value to the tuning device; a step-2 that inputs a target steering torque to the tuning device; a step-3 that calculates a rack thrust force based on a steering torque measured by a sensor system; a step-4 that calculates a necessary motor current based on the step-1 to step-3; and a step-5 that sets the assist map based on the necessary motor current for tuning.

The rack thrust force is calculated based on the parameter value and the motor current of the motor. The control value of each of compensating systems provided in the control unit is nullified to perform the tuning. After the tuning, a simulation of the control value of each of the compensating systems is performed based on the necessary motor current and the control value of each of the compensating systems is optimized based on the simulation. The tuning device forms a steering torque Lissajous waveform diagram relative to a steering angle based on the step-3 and a rack thrust force Lissajous waveform diagram relative to a steering angle based on the step-3. In the step-2, the target steering torque is inputted to the steering torque Lissajous waveform diagram or the rack thrust force Lissajous waveform diagram. The steering torque Lissajous waveform diagram or the rack thrust force Lissajous waveform diagram may be a table or data. Therefore, the above object of the present invention can be achieved more effectively.

### BRIEF DESCRIPTION OF THE DRAWINGS

In the accompanying drawings:

FIG. 1 is a diagram illustrating a configuration example of a typical electric power steering apparatus;

FIG. 2 is a block diagram of an electric power steering apparatus in the related art;

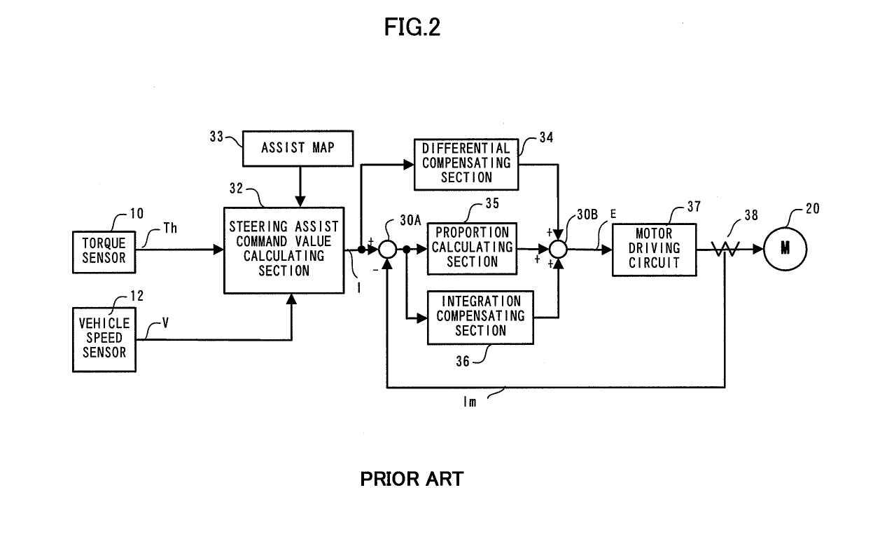

FIG. 3 is a block diagram illustrating a configuration example of a method for tuning an electric power steering apparatus according to the present invention;

FIG. 4 is a simplified diagram illustrating the configuration example of the method for tuning an electric power steering apparatus according to the present invention;

FIG. 5 is a flowchart illustrating an operation example of the present invention;

FIG. 6 is a diagram illustrating an example of a rack thrust force Lissajous waveform diagram according to the present invention;

FIG. 7 is a diagram illustrating an example of a steering torque Lissajous waveform diagram according to the present invention; and

FIG. 8 is a diagram illustrating a characteristic example of necessary motor currents according to the present invention.

### BEST MODE FOR CARRYING OUT THE INVENTION

In a method for tuning an electric power steering apparatus according to the present invention, a tuning device is connected to a control unit of an electric power steering apparatus. The output of each of compensating systems (such as phase compensation, inertia compensation, converging control, etc.) provided in the electric power steering apparatus is nullified. A steering torque and a motor current detected in the range of each arbitrary steering angle (e.g., every 5 [deg] of −25 [deg] to +25 [deg]) relative to each vehicle speed (e.g., every 10 [km/h] of 10 to 80 [km/h]) at a typically emphasized steering angle speed or a predetermined steering angle speed (e.g., 30 [deg/sec]) reducing the influence of a motor inertia are measured and inputted. The known parameter values, such as a motor gear ratio, a pinion rack gear ratio, a worm gear efficiency and a pinion rack gear efficiency are inputted and set to the tuning device.

The tuning device calculates a rack thrust force based on the inputted measured values and the predetermined parameter values. The tuning device forms a rack thrust force Lissajous waveform diagram relative to a steering angle at a predetermined vehicle speed (an estimation diagram of a tire reaction force relative to the steering angle) and a steering torque Lissajous waveform diagram relative to a steering angle at a predetermined vehicle speed (a diagram of the steering torque relative to an outputted steering angle).

A test driver or a tuning operator inputs a target steering torque to the steering torque Lissajous waveform diagram relative to the steering angle formed by the tuning device. The tuning device calculates a necessary motor current based on the detected steering torque, the calculated rack thrust force and the inputted target steering torque. The tuning device sets an assist map (look-up table) provided in the control unit based on the calculated necessary motor current.

To optimize a steering assist command value, the output of each of the compensating systems of the electric power steering apparatus is nullified and a simulation of each of the compensating systems is performed by the tuning device based on the state of satisfying the target steering torque (the state of setting the assist map based on the necessary motor current). The tuning device optimizes the steering assist command value based on the optimum parameter of each of the compensating systems determined by the simulation, the target steering torque and the necessary motor current.

An embodiment of the present invention will be described below with reference to the drawings.

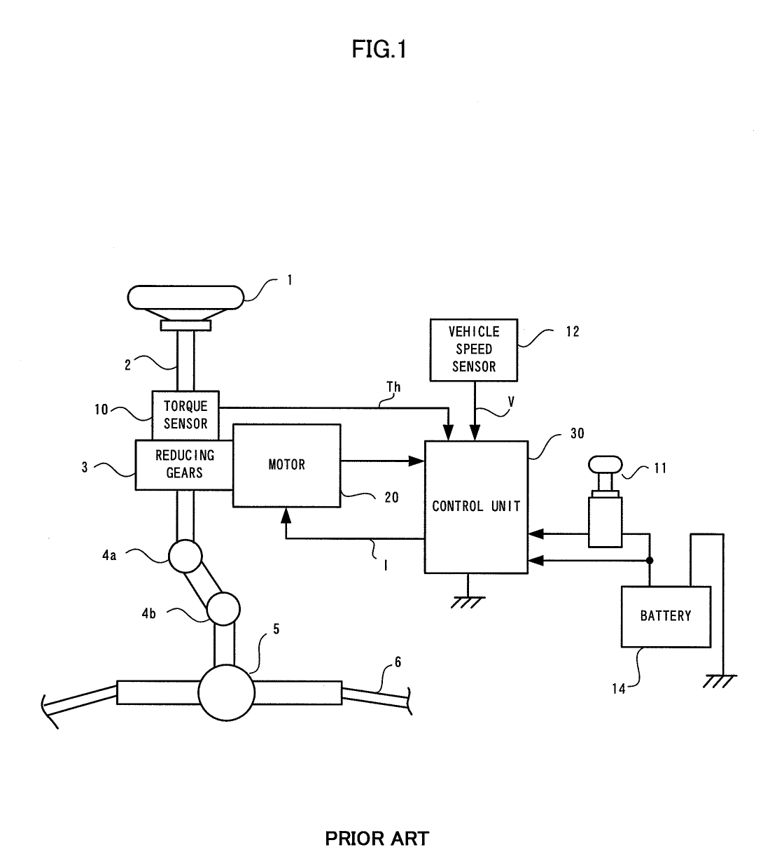

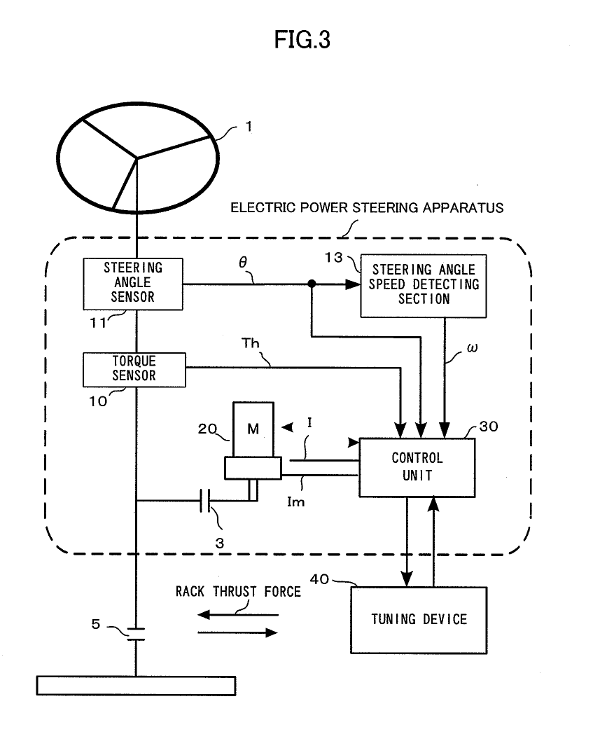

FIG. 3 is a block diagram illustrating a configuration example of the present invention. The configuration of the apparatus embodying the present invention adds a tuning device 40 to the electric power steering apparatus of FIG. 1. The same parts as FIG. 1 are indicated by similar reference numerals and the description will not be repeated.

The tuning device 40 comprises a CPU (not illustrated) executing control of the entire tuning device, a ROM (not illustrated) incorporating an operating program, a RAM (not illustrated) functioning as an operating memory, a communication section (not illustrated), such as a LAN or an RS232C, performing mutual communication with the control unit 30, an input section (not illustrated), such as a mouse, a keyboard or a touch panel, operated by the tuning operator, and a display section (not illustrated) displaying a calculated result and a state. The electric power steering apparatus and the control unit 30 have the same configuration as the related art and the description is omitted.

The test driver or the tuning operator sets the known parameter values, such as the motor gear ratio of the reducing gears 3 and the pinion rack gear ratio and the pinion rack gear efficiency of the pinion rack mechanism 5, which can be determined in advance, from the input section to the tuning device 40.

The tuning device 40 is connected so as to set each of control systems and the assist map 33 of the control unit 30. The tuning device 40 is connected so as to measure a steering angle θ, a steering angle speed ψ, and the steering torque Th of the steering wheel 1 and the motor current Im flowing to the motor 20, which are inputted to the control unit 30. At a measurement time, it is ideal to perform a tuning in the state of being unaffected by each of the compensating systems. The output of each of the compensating systems provided in the control unit 30 is turned-off to supply the steering assist command value I to the motor 20 without being interfered by each of the compensating systems. The steering angle θ, the steering angle speed ω, the steering torque Th of the steering wheel 1 and the motor current Im flowing to the motor 20 are measured.

The tuning device 40 calculates a rack thrust force F based on the steering angle θ, the steering angle speed ω, the steering torque Th and the motor current Im from the sensor system. The tuning device 40 calculates a necessary motor current Imt based on a target steering torque Tmh inputted by the tuning operator and the rack thrust force F. The tuning device 40 sets the necessary motor current Imt to the assist map 33. Thus, the tuning device 40 outputs the steering assist command value I satisfying the target steering torque Tmh to the motor 20.

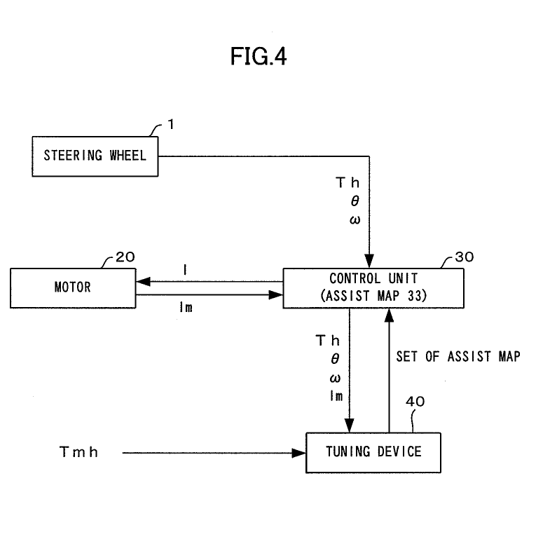

FIG. 4 is a block diagram simplifying the path of a signal and information of FIG. 3. The same parts as FIG. 3 are indicated by similar reference numerals and the description will not be repeated.

The detection signal of the steering torque Th, the steering angle θ, and the steering angle speed ω is inputted from the sensor system provided in the steering wheel 1 to the control unit 30. The motor current Im detected by the motor current detecting section 38 provided in the motor 20 is also inputted to the control unit 30. The steering torque Th, the steering angle θ, the steering angle speed ω, and the motor current Im inputted to the control unit 30 are measured by the tuning device 40. The tuning device 40 calculates the rack thrust force F based on the measured values. The tuning device 40 calculates the necessary motor current Imt based on the target steering torque Tmh inputted by the tuning operator and the calculated rack thrust force F. The tuning device 40 sets the assist map 33 based on the necessary motor current Imt.

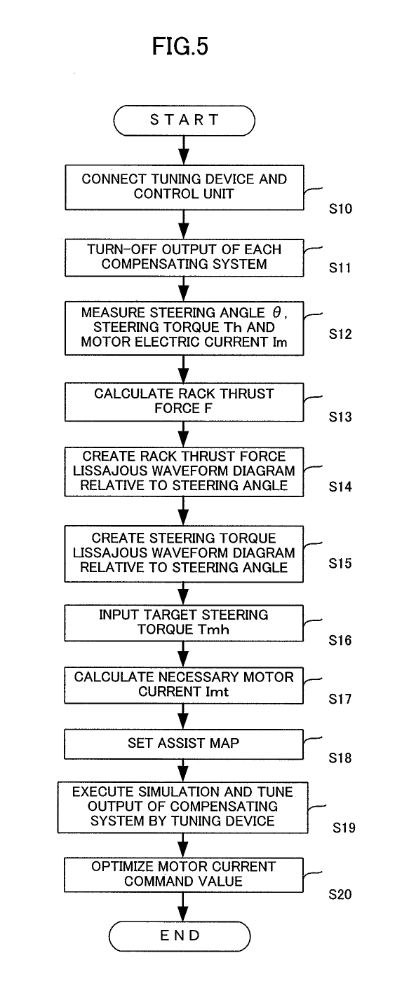

FIG. 5 is a flowchart illustrating an operating example of the present invention. The present invention will be described with reference to the flowchart.

The test driver or the tuning operator connects the tuning device 40 to the control unit 30 of the electric power steering apparatus provided in the real vehicle (Step S10). The each output of the compensating systems (phase compensation, inertia compensation, converging control, etc.) of the electric power steering apparatus is nullified by the tuning device 40 (Step S11).

The test driver or the tuning operator sets a known motor gear ratio Gr, a pinion rack gear ratio Cf, a worm gear efficiency μ1 and a pinion rack gear efficiency μ2 as the parameter values to the tuning device 40 so as to measure the steering angle θ and the steering angle speed ω from the steering sensor 11 and the steering torque Th from the torque sensor 10, and the motor current Im from the motor current detecting section 38 by the tuning device. The test driver or the tuning operator measures the actually outputted steering torque Th and motor current Im in the range of each arbitrary steering angle (e.g., every 5 [deg] of −25 [deg] to +25 [deg]) relative to each vehicle speed (e.g., every 10 [km/h] of 10 to 80 [km/h]) at a typically emphasized steering angle speed or a predetermined steering angle speed (e.g., 30 [deg/sec]) reducing the influence of a motor inertia (Step S12).

The rack thrust force F is calculated by the rack thrust force calculating equation as the following (1) equation based on the measured values in the Step S12 and the set values (Step S13).

F=(Th+Kt×Im×Gr×μ1)×2π/Cf×μ2×1000 (1)

where Kt is a motor torque constant.

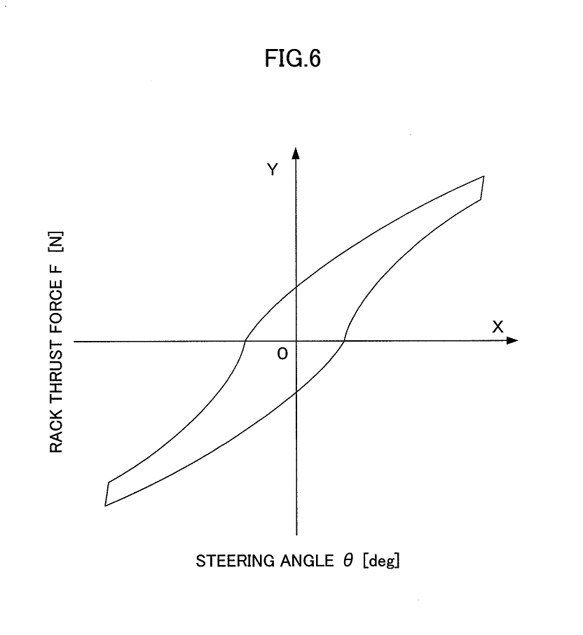

Based on the rack thrust force F[N] of the above (1) equation, as illustrated in FIG. 6, the rack thrust force Lissajous waveform diagram relative to the steering angle θ [deg] is created in the range of an arbitrary steering angle (Step S14).

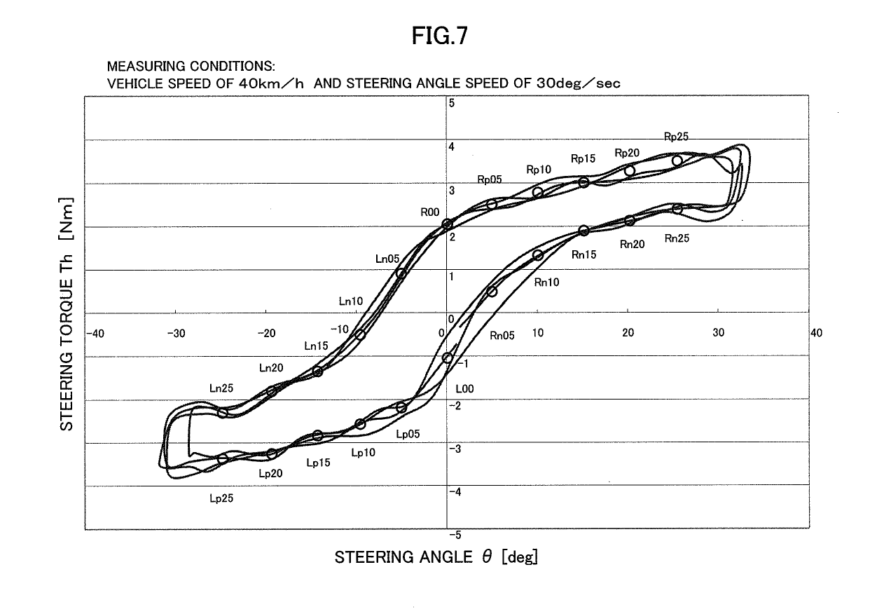

Based on the measured value of the actually outputted steering torque Th[Nm] detected in the Step S12, as illustrated in FIG. 7, the steering torque Lissajous waveform diagram relative to the steering angle θ [deg] is created in the range of an arbitrary steering angle (Step S15).

The target steering torque Tmh relative to each of the steering angles θ is inputted to the tuning device 40 with reference to the rack thrust force Lissajous waveform diagram (FIG. 6) and the steering torque Lissajous waveform diagram (FIG. 7) displayed on the tuning device 40 (Step S16). The tuning device 40 calculates the necessary motor current Imt based on the target steering torque Tmh inputted in the Step S16 (Step S17). The necessary motor current Imt is calculated based on the following (2) equation from the rack thrust force F determined from the above (1) equation, the inputted target steering torque Tmh, the predetermined motor torque constant Kt, the motor gear ratio Gr, the worm gear efficiency μ1, the pinion rack gear efficiency μ2 and the pinion rack gear ratio Cf.

Imt=(Cf×F−2π×2×Tmh×1000)/2π/Kt/μ1/μ2/Gr/1000 (2)

The tuning device 40 sets the assist map 33 based on the necessary motor current Imt calculated from the above (2) equation (Step S18).

The tuning device 40 performs a simulation of each of the compensating systems in the state of setting the necessary motor current Imt to the assist map 33 in the Step S18 to optimize each of the compensating systems (Step S19). From each of the compensating systems optimized in the Step S19, the target steering torque Tmh, and the necessary motor current Imt, the steering assist command value I outputted from the control unit 30 can be efficiently optimized (Step S20).

The state that the target steering torque Tmh is inputted to the steering torque Lissajous waveform diagram relative to the steering angle θ determined by the tuning device 40 for tuning will be described with reference to FIG. 7.

In FIG. 7, the X-axis direction indicates the steering angle θ [deg] of the steering wheel and the Y-axis direction indicates the steering torque Th [Nm]. In the range of ±25 [deg] in the X-axis direction under the measuring conditions at a vehicle speed of 40 km/h and at a steering angle speed of 30 [deg/sec], the steering torque Th every 5 [deg] in the turning/returning operation of the right and left steering of the steering wheel 1 is displayed by the tuning device 40 and the target steering torque Tmh is inputted and set. Each point represents a steering operation by a combination of right steering R and turning p or returning n or a combination of left steering L and turning p or returning n. By way of example, “Rp” represents “turning of the right steering” and “Ln” represents “returning of the left steering”. The set point (every 5 deg) of the steering torque Th indicated by a circle in the drawing is inputted as the target steering torque Tmh. The set point (every 5 deg) can be tuned on the display section of the tuning device 40 by freely moving the point by the mouse of the input section.

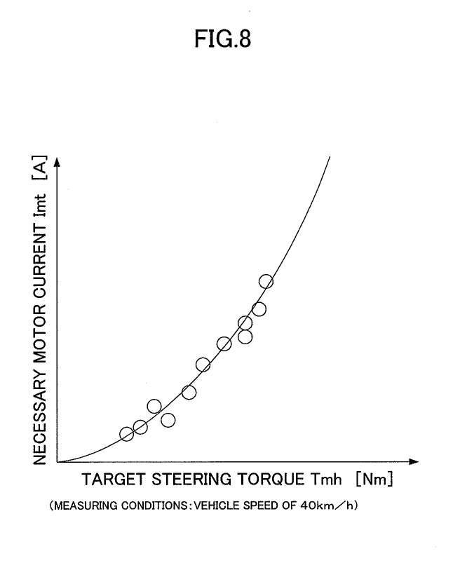

After the target steering torque Tmh is inputted, the necessary motor current Imt calculated by the tuning device 40 is automatically calculated using the above (2) equation at each arbitrary steering angle relative to each vehicle speed. The target steering torque Tmh and the necessary motor current Imt are set to the assist map 33. FIG. 8 illustrates a characteristic example of the necessary motor current Imt relative to the target steering torque Tmh.

FIG. 8 illustrates a characteristic example of the necessary motor current Imt calculated based on the target steering torque Tmh inputted in FIG. 7. The tuning device 40 sets the necessary motor current Imt as the assist map 33 by the characteristic illustrated in FIG. 8.

The necessary motor current Imt may be calculated as follows. The necessary motor current Imt may be automatically calculated by the tuning device 40 based on the rack thrust force F calculated by the above equation (2) and the inputted and expected target steering torque Tmh. The expected target steering torque Tmh may be automatically plotted on the steering torque Lissajous waveform diagram created by the tuning device 40. The necessary motor current Imt may be automatically calculated by the tuning device 40. The steering torque Lissajous waveform diagram and the rack thrust force Lissajous waveform diagram relative to the steering angle θ may be a table. The necessary motor current Imt may be calculated as data or be set to the assist map 33. Alternatively, in the input of the target steering torque Tmh, when the numerical value of the target steering torque is inputted to the tuning device 40, the necessary motor current Imt may be calculated. The same effect can be obtained.

### INDUSTRIAL APPLICABILITY

According to the method for tuning an electric power steering apparatus of the present invention, the output of each of the compensating systems provided in the electric power steering apparatus is nullified without using a special sensor or a measuring device, and based on the detected value from the sensor system typically provided in the electric power steering apparatus, and further, based on the steering torque detected by the tuning device, the rack thrust force calculated by the tuning device, and the target steering torque inputted to the tuning device, the necessary motor current is calculated and is set to the assist map. Therefore, the efficiency of the tuning operation can be improved and the necessary cost can be reduced.

The output of each of the compensating systems of the electric power steering apparatus is nullified. A simulation of the output of each of the compensating systems is performed by the tuning device in the state of satisfying the target steering torque. The steering assist command value and each of the compensating systems can be optimized.

1-7. (canceled)

8. A method for tuning an electric power steering apparatus that tunes the electric power steering apparatus that calculates a steering assist command value based on an assist map provided in a control unit and controls a motor that provides a steering assist force to a steering mechanism based on the steering assist command value by a tuning device connected to the control unit, the method comprising the steps of:
setting a predetermined parameter value to the tuning device;
inputting a target steering torque to the tuning device;
calculating a rack thrust force based on a steering torque measured by a sensor system;
calculating a necessary motor current based on the proceeding steps; and
setting the assist map based on the necessary motor current for tuning.

9. The method for tuning an electric power steering apparatus according to claim 8, wherein the rack thrust force is calculated based on the parameter value and the motor current of the motor.

10. The method for tuning an electric power steering apparatus according to claim 8, wherein the control value of each of compensating systems provided in the control unit is nullified to perform the tuning.

11. The method for tuning an electric power steering apparatus according to claim 9, wherein the control value of each of compensating systems provided in the control unit is nullified to perform the tuning.

12. The method for tuning an electric power steering apparatus according to claim 8, wherein after the tuning, a simulation of the each control value of the compensating systems is performed based on the necessary motor current and the control value of each of the compensating systems is optimized based on the simulation.

13. The method for tuning an electric power steering apparatus according claim 8, wherein the tuning device forms a steering torque Lissajous waveform diagram relative to a steering angle based on the first calculating step and a rack thrust force Lissajous waveform diagram relative to a steering angle based on the first calculating step.

14. The method for tuning an electric power steering apparatus according claim 9, wherein the tuning device forms a steering torque Lissajous waveform diagram relative to a steering angle based on the first calculating step and a rack thrust force Lissajous waveform diagram relative to a steering angle based on the first calculating step.

15. The method for tuning an electric power steering apparatus according claim 10, wherein the tuning device forms a steering torque Lissajous waveform diagram relative to a steering angle based on the first calculating step and a rack thrust force Lissajous waveform diagram relative to a steering angle based on the first calculating step.

16. The method for tuning an electric power steering apparatus according to claim 13, wherein in the inputting step, the target steering torque is inputted to the steering torque Lissajous waveform diagram or the rack thrust force Lissajous waveform diagram.

17. The method for tuning an electric power steering apparatus according to claim 16, wherein the steering torque Lissajous waveform diagram or the rack thrust force Lissajous waveform diagram is a table or data.
